(19) United States
(12) Patent Application Publication
(10) Pub. No.: US 2026/0356642 A1
(43) Pub. Date: Nov. 12, 2026

(54) TRANSPORT MACHINE WITH SAFETY PROTECTION MECHANISM

(71) Applicant: LIFEBRITE INTERNATIONAL CORP., Taichung City (TW)

(72) Inventors: YU-CHUAN HO, TAICHUNG CITY (TW); CHIA-HAO CHUANG, Taichung City (TW)

(21) Appl. No.: 19/201,086

(22) Filed: May 7, 2025

(51) Int. Cl. B66F 9/07; B62B 3/02; B62B 3/04; B62B 5/00; B62B 5/06; B66F 17/00

(52) U.S. Cl. CPC B66F 9/07; B62B 3/02; B62B 3/04; B62B 5/0006; B62B 5/063; B66F 17/003; B62B 5/0033; B62B 2206/003; B62B 2206/06

(57) ABSTRACT

A transport machine with safety protection mechanism includes a machine body, a manipulate device, a carrying platform, a lifting control device, and a protection device. The protection device has a gate and a sensor. When the gate opens, the sensor generates a first signal; and the manipulate device and the lifting control device accordingly refrain the machine body and the carrying platform from moving, and the roller control device controls the rollers to rotate, so as to move the object. When the gate closes, the sensor generates a second signal; the manipulate device and the lifting control device accordingly control the machine body and the carrying platform to move, and the roller control device refrains the rollers from rotating, thereby fixing the object. Thus, the protection device prevents the manipulate device and lifting control device from accidental activation and improves operational safety.

### BACKGROUND OF THE DISCLOSURE

### 1. Field of the Disclosure

The present disclosure relates to transport machines, and more particularly, to a transport machine with safety protection mechanism, whose manipulate device and lifting control device are prevented from being accidentally activated to cause damage of objects.

### 2. Description of the Related Art

In modern industrial and logistics operations, transport machines are widely used to improve operational efficiency and reduce labor burdens, primarily used for carrying and moving objects, and delivering objects to designated heights by use of lifting mechanisms.

However, conventional transport machines still have disadvantages in terms of safety and operational control. More particularly, during the transportation of objects, lack of comprehensive protection and locking mechanism may cause the machine body to continuously move due to operational errors, or to cause the carrying platform to ascend or descend abnormally due to accidental touches. Such inconvenience may lead to objects shaking or tipping during movement, thereby increasing the risk of objects toppling or being damaged, even posing threat to the safety of operational staff.

### SUMMARY OF THE DISCLOSURE

To improve the issues above, the present disclosure provides a transport machine with safety protection mechanism, whose protection device effectively prevents the manipulate device and the lifting control device from being accidentally activated to cause objects damage during transportation, thereby enhancing safety of transport operation.

For achieving the aforementioned objectives, a transport machine with safety protection mechanism in accordance with an embodiment of the present disclosure comprises:
a manipulate device connected with the base of the machine body and configured to drive the machine body to move;
a carrying platform connected with the lifting rail of the machine body, the carrying platform configured to carry an object and ascend and descend along the upright frame; the carrying platform having a pedestal, a plurality of rollers, and a roller control device, the pedestal movably disposed on the lifting rail and configured to carry the object, with an opening arranged on one side of the pedestal, so that the object is loaded and unloaded through the opening; the rollers are disposed on the pedestal at intervals along a transport direction for supporting the object and moving the object along the transport direction, the roller control device disposed on the pedestal and configured to control the rollers to rotate;
a lifting control device configured to control the carrying platform to ascend and descend along the upright frame, the lifting control device having a controller, a driving source, and a lifting control button that are coupled with each other, the controller receiving a lifting/lowering signal generated by the lifting control button being pressed, the driving source driving the carrying platform to move according to the lifting/lowering signal; and
a protection device disposed on the carrying platform, the protection device having a gate and a sensor, the gate disposed at the opening of the pedestal, the sensor coupled with the manipulate device, the roller control device, and the lifting control device for detecting opening and closing of the gate; when the gate opens, the sensor generates a first signal and transmits the first signal to the manipulate device, the roller control device, and the lifting control device, the manipulate device refrains the machine body from moving according to the first signal, the lifting control device refrains the driving source from driving the carrying platform to move according to the first signal, and the roller control device controls the rollers to rotate according to the first signal, such that the object moves along the transport direction; when the gate closes, the sensor generates a second signal and transmits the second signal to the manipulate device, the roller control device, and the lifting control device, the manipulate device controls the machine body to move according to the second signal, the lifting control device receives the lifting/lowering signal transmitted by the lifting control button according to the second signal, so that the driving source drives the carrying platform to move, and the roller control device refrains the rollers from rotating according to the second signal, thereby fixing the object on the pedestal.

With such configuration, when the present disclosure is to be used to transport an object while the gates opens, the manipulate device and the lifting control device are refrained from being controlled, so as to prevent the machine body and the carrying platform from moving due to accidental touching or operational errors, thereby improving the safety of transportation.

Also, the sensor of the present disclosure converts the gate status into a signal and immediately transmits the signal to the manipulate device, the roller control device, and the lifting control device, achieving an automatic operation and safety locking mechanism. Also, according to the first or the second signal, the manipulate device, the roller control device, and the lifting control device are automatically controlled, so as to refrain or allow the control operations without the need of manual intervention, thereby enhancing the operational efficiency and achieving an intelligent operation control.

In addition, the driving mechanism of the present disclosure for controlling the movement of the machine body is allowed to stably control the movement of the machine body, preventing objects from damage or tipping due to fast movement.

Further, the first lifting control button disposed on the machine body and the second lifting control button disposed on the carrying platform allow the operational staff to carry out the lifting and lowering control at different locations, increasing the operational convenience.

Furthermore, when the gate opens, the warning device of the present disclosure sends out a remind signal, further increasing the alertness of operational staff, preventing occurrence of accident or erroneous operation.

### BRIEF DESCRIPTION OF THE DRAWINGS

FIG. 1 is a perspective view of an embodiment of the present disclosure.

FIG. 2 is a perspective view of an embodiment of the present disclosure taken from another point of view.

FIG. 3 is a side view of an embodiment of the present disclosure.

FIG. 4 is a partially enlarged of an embodiment of the present disclosure.

FIG. 5 is a schematic view of an embodiment of the present disclosure, illustrating the gate opened.

FIG. 6 is another schematic view of an embodiment of the present disclosure, illustrating the gate closed.

FIG. 7 is a perspective view of another embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

The directional terms of, for example, “up”, “down”, “front”, “rear”, “left”, “right”, “inner”, “outer”, and “side” are only used herein for illustrating the relative directions shown in the drawings. Therefore, the directional terms are applied for the purpose of illustration and understanding of the present disclosure, instead of limiting the present disclosure.

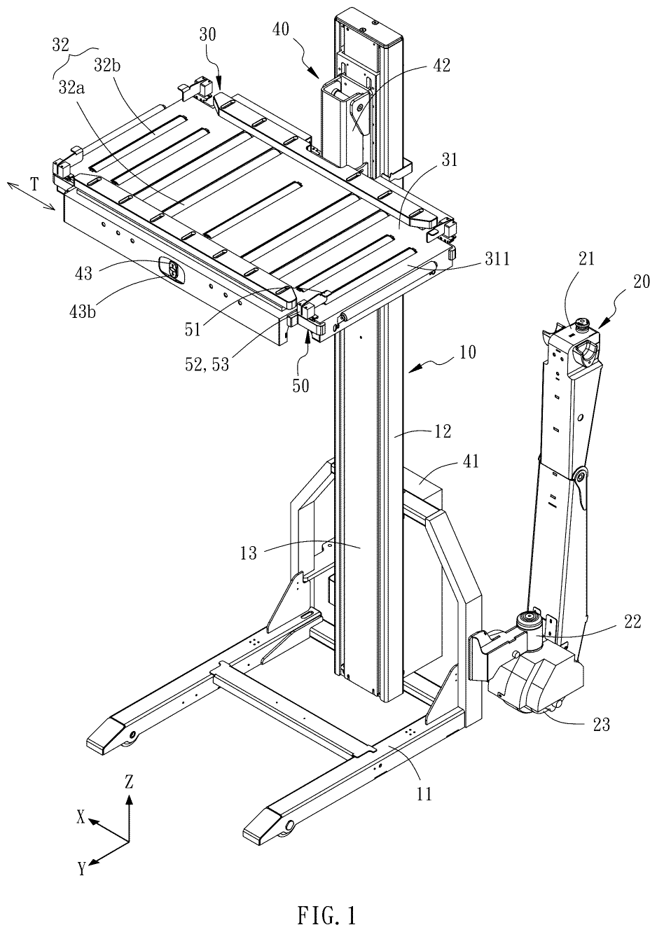

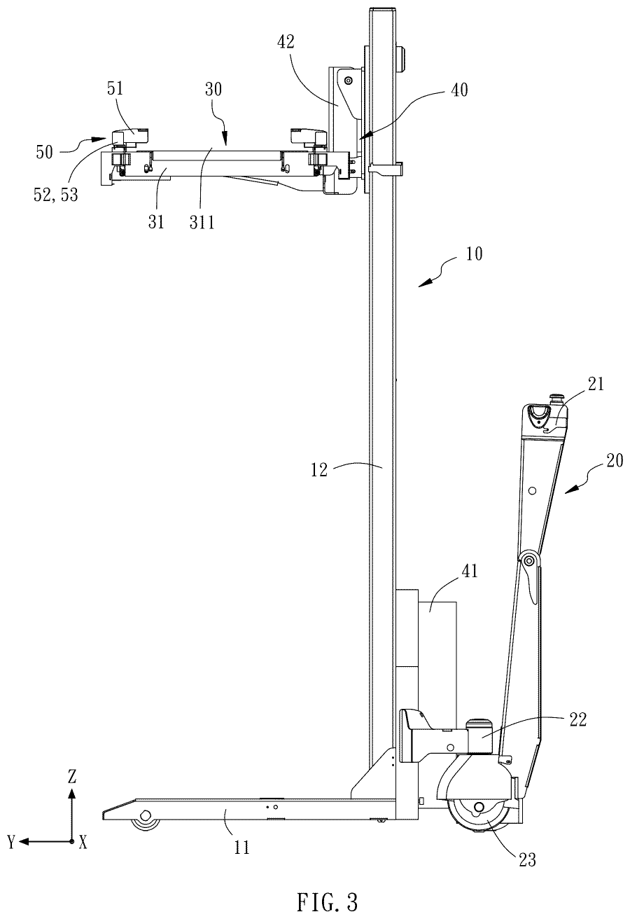

Referring to FIG. 1 to FIG. 7, the present disclosure provides a transport machine with safety protection mechanism used for

### Transporting an Object G.

The transport machine with safety protection mechanism provided by the present disclosure comprises a machine body 10, a manipulate device 20, a carrying platform 30, a lifting control device 40, and a protection device 50.

The machine body 10 comprises a base 11 and an upright frame 12 disposed on the base 11, with a lifting rail 13 disposed on one side of the upright frame 12, as shown by FIG. 1.

The manipulate device 20 is connected with the base 11 of the machine body 10, and configured to drive the machine body 10 to move. The manipulate device 20 comprises a steering control 21, a driving mechanism 22, and a movement wheel 23. The driving mechanism 22 is connected with the steering control 21 and the movement wheel 23. The steering control 21 is configured to control the movement direction of the movement wheel 23 driven by the driving mechanism 22, such as moving forward, backward, leftward, and rightward. Also, the driving mechanism 22 also controls whether the movement wheel 23 operates, thereby controlling the movement of the machine body 10. In the embodiment, the driving mechanism 22 is a deceleration mechanism.

The carrying platform 30 is connected with the lifting rail 13 of the machine body 10. The carrying platform 30 is allowed to carry the object G and ascend and descend along the upright frame 12. Therein, the carrying platform 30 comprises a pedestal 31, a plurality of rollers 32, and a roller control device 33. The pedestal 31 is movably disposed on the lifting rail 13 and configured to carry the object G, with an opening 311 formed on one side of the pedestal 31, so that the object G is loaded and unloaded through the opening 311. The rollers 32 are disposed on the pedestal 31 at intervals along a transport direction T for supporting the object G and moving the object G along the transport direction T.

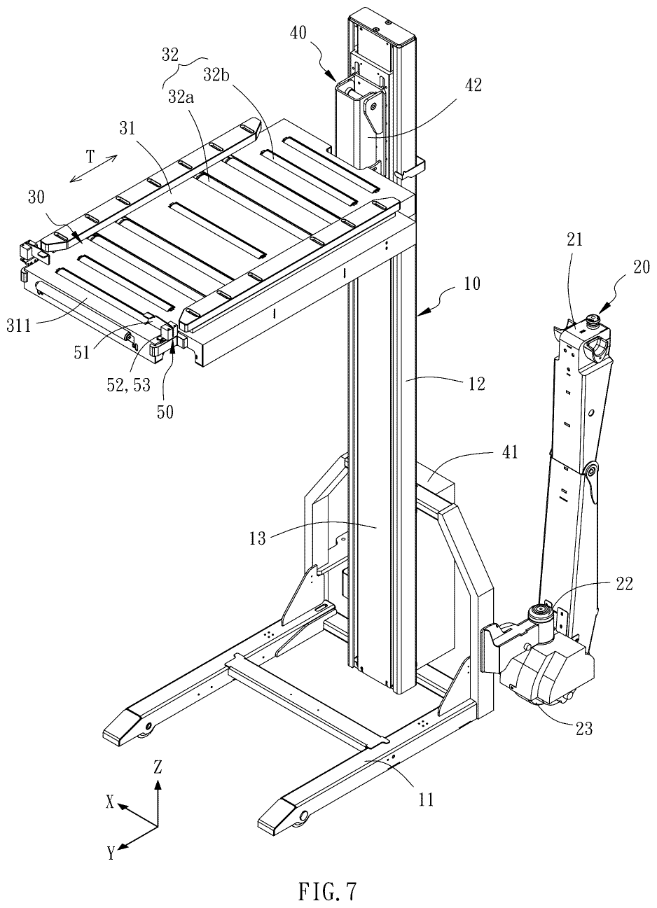

Referring to FIG. 1, in the first embodiment, the opening 311 is formed on two sides of the X axis of the machine body 10, and the transport direction T is arranged in parallel to the X axis of the machine body 10. Referring to FIG. 7, in the second embodiment, the opening 311 is formed on one side of the pedestal 31 in opposite to the Y axis of the machine body 10, and the transport direction T is arranged in parallel to the Y axis of the machine body 10. Therefore, the present disclosure allows the direction of the opening 311 be variably configured based on different environmental or transport requirements, facilitating the loading and unloading of the object G.

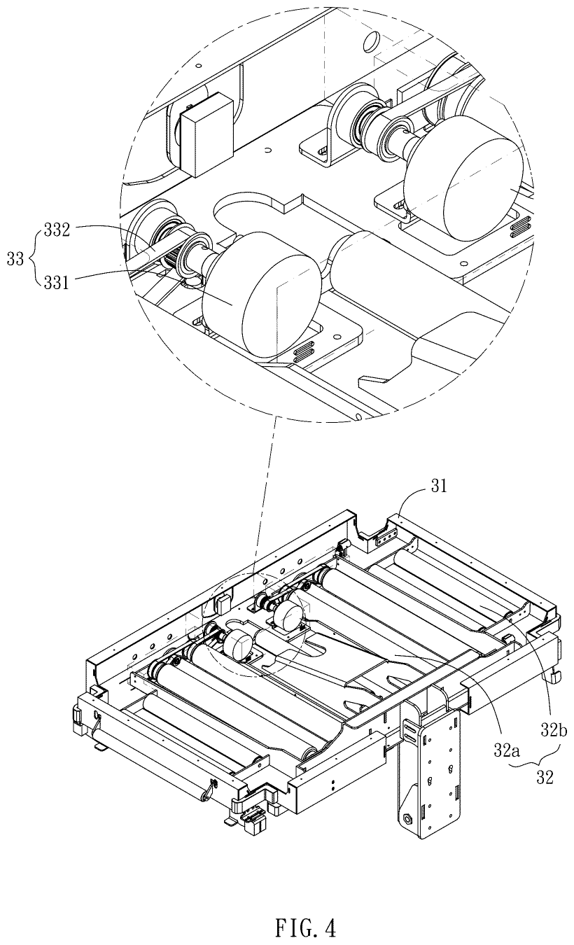

Also, the roller control device 33 is disposed on the pedestal 31 and configured to control the rotation of each rollers 32. The rollers 32 include a plurality of main rollers 32a and a plurality of auxiliary rollers 32b. The roller control device 33 comprises a plurality of power sources 331 and a plurality of transmission belts 332. Each power source 331 is connected with each main roller 32a through the corresponding transmission belts 332, and one end of each main roller 32a is connected to one another through respective transmission belts 332, as shown by FIG. 4. The auxiliary rollers 32b are disposed at the opening 311 at intervals and pushed to rotate by the object G. Therein, when the roller control device 33 controls each of the main roller 32a to rotate, the object G moves along the transport direction T on the pedestal 31, and the object G contacts and pushes each of the auxiliary roller 32b to move during the movement. Also, each auxiliary roller 32b provides additional support to reduce the friction between the object G and the pedestal 31, allowing the object G to be more stably loaded onto and unloaded from the carrying platform 30, preventing jamming or deviation. In the embodiment, the power source 331 is a motor.

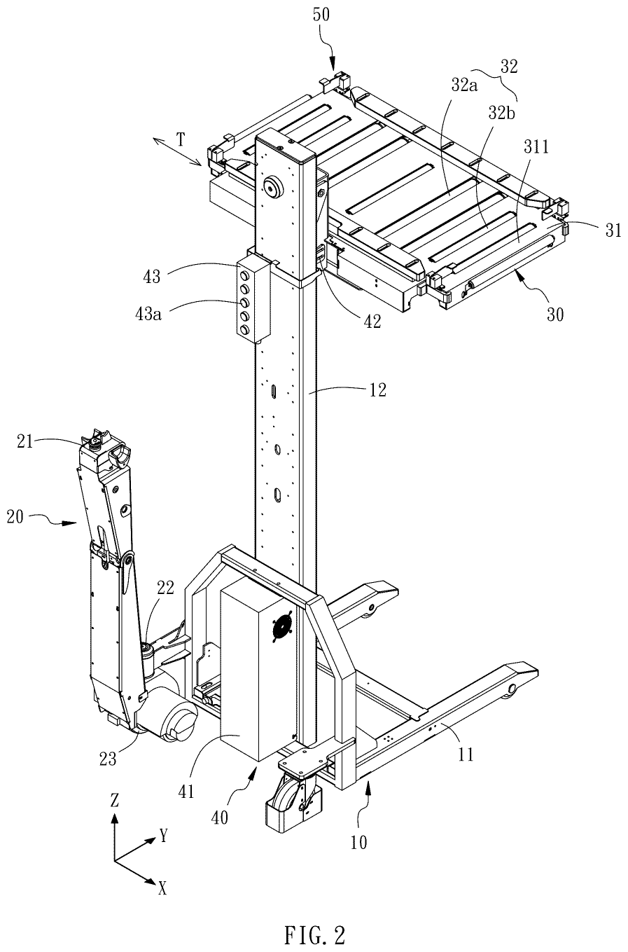

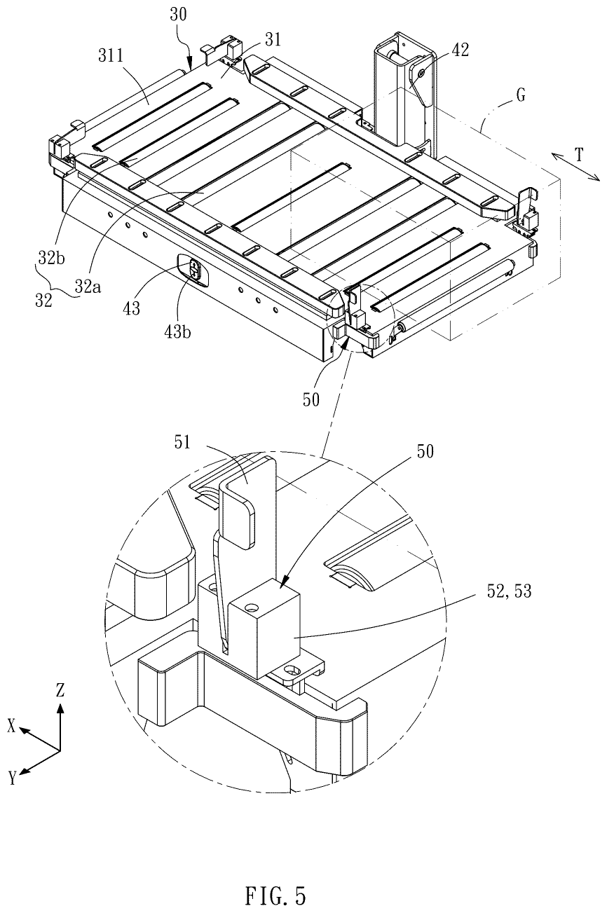

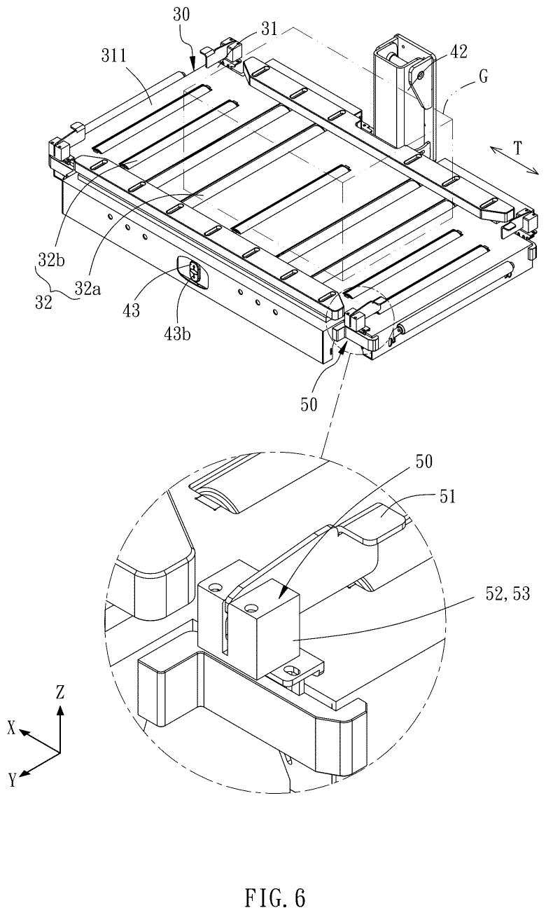

The lifting control device 40 is configured to control the carrying platform 30 to ascend and descend along the upright frame 12 of the machine body 10. The lifting control device 40 comprises a controller 41, a driving source 42, and a lifting control button 43 that are coupled with each other. The controller 41 and the driving source 42 are disposed in the upright frame 12. Therein, when the lifting control button 43 is pressed, the lifting control button 43 generates a lifting/lowering signal, which is received by the controller 41. The driving source 42 drives the carrying platform 30 to move according to the lifting/lowering signal. Therein, in the embodiment, the lifting control button 43 includes a first lifting control button 43a and a second lifting control button 43b. The first lifting control button 43a is disposed on the upright frame 12 (as shown by FIG. 2), and the second lifting control button 43b is disposed on the carrying platform 30 (as shown by FIG. 1, FIG. 5, and FIG. 6). When the first lifting control button 43a or the second lifting control button 43b is pressed, the controller 41 receives the lifting/lowering signal generated by the first lifting control button 43a or the second lifting control button 43b.

The protection device 50 is disposed on the carrying platform 30, and comprises a gate 51, a sensor 52, and a warning device 53. The gate 51 is disposed at the opening 311 of the pedestal 31. The sensor 52 is coupled with the manipulate device 20, the roller control device 33, the lifting control device 40, and the warning device 53. The sensor 52 detects the opening and closing of the gate 51. Therein, a plurality of gates 51 and sensors 52 are included, and each gate 51 and each sensor 52 are disposed at the opening 311, respectively. In the embodiment, one gate 51 is disposed on two side of the opening 311, respectively, with one sensor 52 disposed corresponding to each gate 51. In the embodiment, the sensor 52 is an optical sensor.

Referring to FIG. 1, FIG. 2, and FIG. 5, when the gate 51 opens, the sensor 52 is shielded by the gate 51 and generates a first signal, and the sensor 52 simultaneously transmits the first signal to the driving mechanism 22 of the manipulate device 20, each power source 331 of the roller control device 33, the controller 41 of the lifting control device 40, and the warning device 53. The manipulate device 20 refrains the driving mechanism 22 from driving the machine body 10 to move according to the first signal. The controller 41 of the lifting control device 40 refrains the driving source 42 from driving the carrying platform 30 to move according to the first signal. Each power source 331 of the roller control device 33 controls each main roller 32a to rotate according to the first signal, so that the object G moves along the transport direction T. Therein, the warning device 53 receives the first signal to generate a remind signal, which is allowed to be a sound, light, or a combination thereof. In the embodiment, the form of the warning device 53 is not limited.

Referring to FIG. 1, FIG. 2, and FIG. 6, when the gate 51 closes, the sensor 52 is not shield and generates a second signal, and the sensor 52 simultaneously transmits the second signal to the driving mechanism 22 of the manipulate device 20, each power source 331 of the roller control device 33, and the controller 41 of the lifting control device 40. The driving mechanism 22 of the manipulate device 20 controls the machine body 10 to move according to the second signal. The controller 41 of the lifting control device 40 receives the lifting/lowering signal transmitted by the lifting control button 43 according to the second signal, so that the driving source 42 drives the carrying platform 30 to move. Each power source 331 of the roller control device 33 refrains each main roller 32a from rotating according to the second signal, thereby fixing the object G on the pedestal 31.

With the foregoing configuration, advantages of the present disclosure will be illustrated below.

Regarding the transport machine with safety protection mechanism provided by the present disclosure, when the gate 51 opens for transport an object G, the manipulate device 20 and the lifting control device 40 are refrained from being controlled, so as to prevent the machine body 10 and the carrying platform 30 from moving due to accidental touches or erroneous operation, effectively improving the transportation safety.

The sensor 52 converts the status of the gate 51 into a signal and immediately transmits the signal to the manipulate device 20, the roller control device 33, and the lifting control device 40, achieving an automatic operation and safety locking mechanism.

According to the first or second signal generated by the sensor 52, the present disclosure automatically controls the manipulate device 20, the roller control device 33, and the lifting control device 40 to refrain or allow the relative operations without the need of manual interception, thereby improving the operation efficiency and achieving an intelligent operation control.

The present disclosure controls the movement of the machine body 10 through the driving mechanism 22, which is a deceleration mechanism, so as to reduce the output speed and increase the torque, stabilizing the machine body 10, thereby preventing inaccurate positioning or shaking of the object G caused by excessive speed. Also, by enlarging the torque through the deceleration mechanism, the machine body 10 is able to carry a heavier object G, so as to be suitable for transporting large or heavy cargo. Additionally, the deceleration mechanism reduces the movement speed, helping to minimize the impact caused by rapid activation or stopping, thereby reducing the risk of slipping or tipping of the object G and enhancing the safety of operation staff.

The present disclosure is provided with the first lifting control button 43a disposed on the machine body 10 and the second lifting control button 43b disposed on the carrying platform 30, allowing the operation staff to carry out the control operation at different positions according to the actual operation conditions, improving the operational convenience.

When the gate 51 opens, the warning 53 sends out a remind signal, increasing the alertness of operational staff, preventing occurrence of accident or erroneous operation.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A transport machine with safety protection mechanism for transporting an object, the transport machine comprising:
a machine body having a base and an upright frame disposed on the base, with a lifting rail disposed on one side of the upright frame;
a manipulate device connected with the base of the machine body and configured to drive the machine body to move;
a carrying platform connected with the lifting rail of the machine body, the carrying platform configured to carry the object and ascend and descend along the upright frame; the carrying platform having a pedestal, a plurality of rollers, and a roller control device, the pedestal movably disposed on the lifting rail and configured to carry the object, with an opening arranged on one side of the pedestal, so that the object is loaded and unloaded through the opening; the rollers are disposed on the pedestal at intervals along a transport direction for supporting the object and moving the object along the transport direction, the roller control device disposed on the pedestal and configured to control the rollers to rotate;
a lifting control device configured to control the carrying platform to ascend and descend along the upright frame, the lifting control device having a controller, a driving source, and a lifting control button that are coupled with each other, the controller receiving a lifting/lowering signal generated by the lifting control button being pressed, the driving source driving the carrying platform to move according to the lifting/lowering signal; and
a protection device disposed on the carrying platform, the protection device having a gate and a sensor, the gate disposed at the opening of the pedestal, the sensor coupled with the manipulate device, the roller control device, and the lifting control device for detecting opening and closing of the gate; when the gate opens, the sensor generates a first signal and transmits the first signal to the manipulate device, the roller control device, and the lifting control device, the manipulate device refrains the machine body from moving according to the first signal, the lifting control device refrains the driving source from driving the carrying platform to move, and the roller control device controls the rollers to rotate according to the first signal, such that the object moves along the transport direction; when the gate closes, the sensor generates a second signal and transmits the second signal to the manipulate device, the roller control device, and the lifting control device, the manipulate device controls the machine body to move according to the second signal, the lifting control device receives the lifting/lowering signal transmitted by the lifting control button according to the second signal, so that the driving source drives the carrying platform to move, and the roller control device refrains the rollers from rotating according to the second signal, thereby fixing the object on the pedestal.

2. The transport machine of claim 1, wherein the manipulate device comprises a steering control, a driving mechanism, and a movement wheel; the driving mechanism connected with the steering control and the movement wheel; the steering control configured to control the driving mechanism to set a movement direction of the movement wheel; the driving mechanism controls whether the movement wheel operates; the sensor configured to send the first signal or the second signal to the driving mechanism.

3. The transport machine of claim 2, wherein the driving mechanism is a deceleration mechanism.

4. The transport machine of claim 1, wherein the roller control device comprises a plurality of power sources and a plurality of transmission belts; each of the rollers comprises a main roller and a plurality of auxiliary rollers; each of the power sources is connected with each of the main rollers through the corresponding transmission belts; each of the main rollers is connected to one another of the main rollers through each of the corresponding transmission belts; each of the power sources receives the first signal or the second signal, so as to control each of the main rollers to rotate; the auxiliary rollers are disposed at the opening at intervals and pushed to rotate by the object.

5. The transport machine of claim 4, wherein a plurality of the gates and a plurality of the sensors are included; the gates and the sensors are disposed at the opening.

6. The transport machine of claim 5, wherein the opening is formed on two sides of an X axis of the machine body; the transport direction is arranged in parallel to the X axis of the machine body.

7. The transport machine of claim 5, wherein the opening is formed on one side of the pedestal in opposite to an Y axis of the machine body; the transport direction is arranged in parallel to the Y axis of the machine body.

8. The transport machine of claim 5, wherein the sensor is an optical sensor; when the gate opens, the sensor is shielded by the gate and generates the first signal.

9. The transport machine of claim 1, wherein the lifting control button includes a first lifting control button and a second lifting control button; the controller, the driving source, and the first lifting control button are disposed on the upright frame, and the second lifting control button is disposed on the carrying platform; the controller receives the lifting/lowering signal generated by pressing the first lifting control button or the second lifting control button.

10. The transport machine of claim 1, wherein the protection device comprises a warning device coupled with the sensor; the sensor transmits the first signal to the warning device, and the warning device generates a remind signal.
